(19) United States
(12) Patent Application Publication
(10) Pub. No.: US 2018/0037381 A1
(43) Pub. Date: Feb. 8, 2018

(54) STORAGE CONTAINERS FOR VAPORIZER CARTRIDGES

(71) Applicant: JUUL LABS, INC., San Francisco, CA (US)

(72) Inventors: Bryan White, San Francisco, CA (US); Steven Christensen, San Francisco, CA (US); Esteban Duque, San Francisco, CA (US); Alexander Gould, San Francisco, CA (US)

(21) Appl. No.: 15/672,188

(22) Filed: Aug. 8, 2017

Related U.S. Application Data
(60) Provisional application No. 62/372,216, filed on Aug. 8, 2016.

(51) Int. Cl. B65D 50/04

(52) U.S. Cl. CPC B65D 50/04; A61J 1/00

(57) ABSTRACT

A storage container and methods for releasably containing one or more vaporizer cartridges are provided. In an exemplary embodiment, the storage container can include a container cap that can be releasably secured to a container base thereby forming a storage volume configured to contain at least one vaporizer cartridge. In some embodiments, the storage container can include a cradle for positioning the vaporizer cartridge within the storage volume, such as for positioning the vaporizer cartridge relative to a transparent window along the container base. Various embodiments and features of the storage container are disclosed herein.

### CROSS REFERENCE TO RELATED APPLICATIONS

The current application claims priority under 35 U.S.C. § 119(e) to U.S. Provisional patent application Ser. No. 62/372,216 filed on Aug. 8, 2016 and entitled “Zero-Volume Storage Containers For Vaporizer Cartridges,” which is incorporated by reference herein in its entirety.

Storage containers and methods are provided for releasably containing cartridges configured for use with vaporizer devices.

### BACKGROUND

Vaporizer devices, such as electronic vaporizers, can use a heating component, such as a heater or heating element, to increase the temperature of one or more vaporizable materials (e.g., liquid, wax, gel, suspension, loose-leaf, etc.). The vaporizable material can be contained in a vaporizer cartridge configured for coupling to the vaporizer device for vaporizing the vaporizable material, such as for inhaling by a user. For example, a vaporizer cartridge can be uncoupled from a vaporizer device to allow a new or different vaporizer cartridge to be coupled thereto, thus allowing the vaporizer device to be re-used.

The active ingredient in some vaporizable materials can be medicinal or non-medicinal, and can include regulated substances. For example, vaporizer devices can be used to efficiently vaporize and/or aerosolize vaporizable materials contained in vaporizer cartridges to thereby deliver nicotine and/or cannabinoids to a user (e.g., via inhalation). Keeping moisture and air away from the vaporizable material during storage in the vaporizer cartridge can prolong shelf-life of the vaporizable material and effectiveness of active ingredients. Additionally, some of these active ingredients may pose a health risk at high concentrations, such as for children. As such, there is a need for improved storage of vaporizer cartridges, such as to protect against health risks and prolong effectiveness of active ingredients.

### SUMMARY

Various storage containers and methods are disclosed herein for releasably containing one or more items, such as vaporizer cartridges that are configured for use with vaporizer devices. In one embodiment, a storage container can include a container base having a storage region defined by a base sidewall extending from a base plate. The base sidewall can include a first coupling feature. The storage container can include a cradle positioned within the storage region for releasably securing the item within the storage region. The storage container can further include a container cap including an inner cap region defined by a cap sidewall extending from a cap top. The cap sidewall can include a second coupling feature that releasably couples to the first coupling feature to thereby releasably couple the container cap to the container base.

In some aspects, methods associated with the storage container are disclosed. For example, a method can include coupling a vaporizer cartridge to a cradle positioned within a storage region of a storage container. The method can further include securing a container cap of the storage container to a container base of the storage container to thereby contain the vaporizer cartridge in the storage container.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A is a perspective view of one exemplary embodiment of a vaporizer device with a vaporizer cartridge coupled thereto;

FIGS. 1B-1D show front, bottom perspective and top perspective views, respectively, of the cartridge of FIG. 1A;

FIG. 2A is a perspective view of another example of a vaporizer device with another embodiment of a vaporizer cartridge coupled thereto;

FIGS. 2B-2D show front, top perspective and bottom perspective views, respectively, of the cartridge of FIG. 2A;

FIG. 3 is a perspective view of a storage container as described herein;

FIG. 4 is a side view of the cartridge storage container shown in FIG. 3;

FIG. 5 is a bottom view of the bottom of the storage container shown in FIG. 3;

FIG. 6 is a top view of the storage container shown in FIG. 3;

FIG. 7 is a perspective view of the container base of the storage container shown in FIG. 3;

FIG. 8 is a sectional view through the storage container shown in FIG. 3;

FIG. 9 is a perspective view of a container cap of the storage container shown in FIG. 3;

FIGS. 10A-10C illustrate a method of uncoupling the container cap from the container base of the storage container shown in FIG. 3;

FIG. 11 illustrates the storage container shown in FIG. 3 with a vaporizer cartridge coupled to a cradle of the storage container;

FIGS. 12A and 12B is a bottom perspective view and bottom view, respectively, of the storage container of FIG. 11 showing the vaporizer cartridge secured within the cradle and visible through the base plate of the container base;

FIG. 13A is a top perspective view of the cartridge storage container;

FIG. 13B is a first section view of the cartridge storage container of FIG. 13A;

FIG. 13C is a second section view of the cartridge storage container of FIG. 13A;

FIG. 14A is a bottom perspective view of another embodiment of the storage container;

FIG. 14B is a bottom view of the storage container of FIG. 14A;

FIG. 15A is a top view of the container base of the storage container of FIG. 14A showing the cradle for holding a vaporizer cartridge;

FIG. 15B is a perspective view of the container base of FIG. 15A;

FIG. 16A is a bottom view of an embodiment of a base plate including an oval-shaped transparent window;

FIG. 16B is a bottom view of an embodiment of a base plate including a diamond-shaped transparent window;

FIG. 16C is a bottom view of an embodiment of a base plate including a star-shaped transparent window; and

FIG. 16D is a bottom view of an embodiment of a base plate including a rectangular-shaped transparent window.

### DETAILED DESCRIPTION

Storage containers are provided for releasably containing one or more vaporizer cartridges. The storage container can include a container cap that can be releasably secured to a container base thereby forming a storage volume configured to contain at least one vaporizer cartridge. Various embodiments of the storage container are described herein that can provide one or more of a variety of benefits, such as prolonging effectiveness of active ingredients contained within the vaporizer cartridges, maintaining freshness of vaporizable material contained within the vaporizer cartridges, containing liquid and/or gas released from the vaporizer cartridges, and preventing child access to vaporizer cartridges. Furthermore, other benefits provided by some embodiments of the storage containers described herein include improved visibility and interaction with vaporizer cartridges contained within a storage container, as well as providing protection against damage to vaporizer cartridges. Various embodiments of the storage container providing any one or more of the above benefits are described in greater detail below.

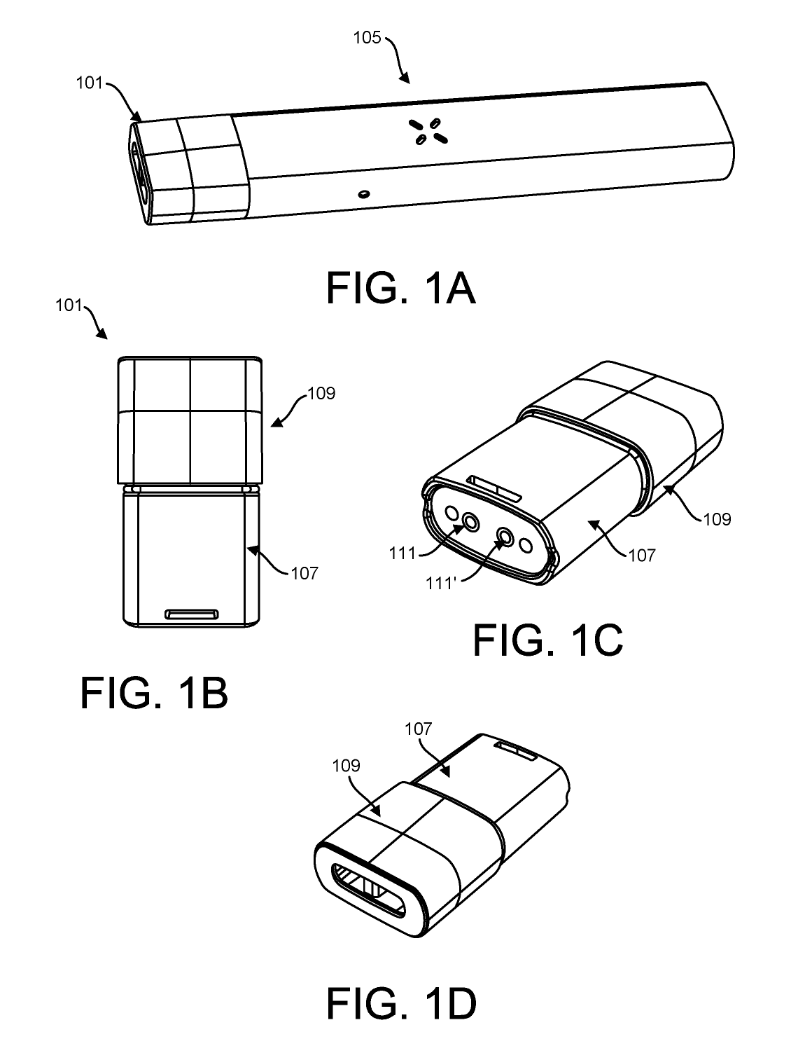

The storage containers described herein can be configured to store a specific size and shaped vaporizer cartridge or can be configured to store a variety of sized and shaped vaporizer cartridges. FIGS. 1A-1D illustrate an embodiment of a vaporizer cartridge 101 that can be contained within the storage containers described herein. For example, FIG. 1A shows the vaporizer cartridge 101 coupled to an embodiment of a vaporizer device 105, such as for vaporizing vaporizable material contained within the vaporizer cartridge 101. Once decoupled from the vaporizer device 105 or prior to becoming coupled to the vaporizer device 105 the vaporizer cartridge 101 can be contained in any one of the storage containers described herein. As shown in FIGS. 1A-1D, for example, the vaporizer cartridge 101 can have a flattened cylindrical shape with a width that is significantly greater than a thickness of the vaporizer cartridge. However, other shaped vaporizer cartridges are within the scope of this disclosure, such as cubic, cylindrical, flattened (or oval) cylindrical, or other cross-sectional shapes, etc. In some embodiments, the vaporizer cartridge can have a length that is between approximately 0.5 centimeters (cm) and approximately 5 cm long, such as 3 cm long. The vaporizer cartridge 101 can include a fluid reservoir 107 that can contain one or more vaporizable materials (e.g., liquid vaporizable material). Any liquid vaporizable material (e.g., formulations of “e-liquids” and the like) can be contained in the fluid reservoir 107. For example, the vaporizable materials can include one or more active ingredients in solution and/or suspension. For example, an active ingredient can include nicotine and/or a cannabinoid.

The vaporizer cartridge 101 can also include one or more heaters, including resistive heaters, such as coils, plates, etc., and a vaporization chamber from which a liquid vaporizable material can be vaporized and inhaled through a mouthpiece 109. The vaporizer cartridge 101 can also include one or more contacts, including pin receiver contacts 111, 111′ (e.g., plates, indentations, plugs, etc.) for connecting to an electrical connector associated with the vaporizer device 105. An air channel may allow air to flow into the vaporizer cartridge 101 (e.g., through a side opening), up through the vaporizer cartridge, over the one or more heaters, and then out of the mouthpiece 109. The vaporizer cartridge 101 can also include various control circuitries (e.g., microcontrollers, etc.) for controlling the one or more heaters, or the control circuitry may be associated with the vaporizer device 105. In some embodiments, the control circuitries can be distributed between the vaporizer cartridge 101 and the vaporizer device 105.

In some embodiments, the vaporizer cartridge 101 can include either electronic or printed information that can be utilized by a user and/or the vaporizer device 105. For example, the vaporizer cartridge 101 can include identification that can be accessed and/or processed electronically, such as for identifying contents within the vaporizer cartridge 101. In some embodiments, the vaporizer cartridge 101 can include printed information (e.g., etched, label, etc.) positioned along one or more sides of the vaporizer cartridge 101. As will be described in greater detail below, some embodiments of the storage container 301 can include at least a part that is transparent for allowing viewing and/or access to such identification (e.g., electronic, printed, etc.) associated with the vaporizer cartridge 101 contained within the storage container 301.

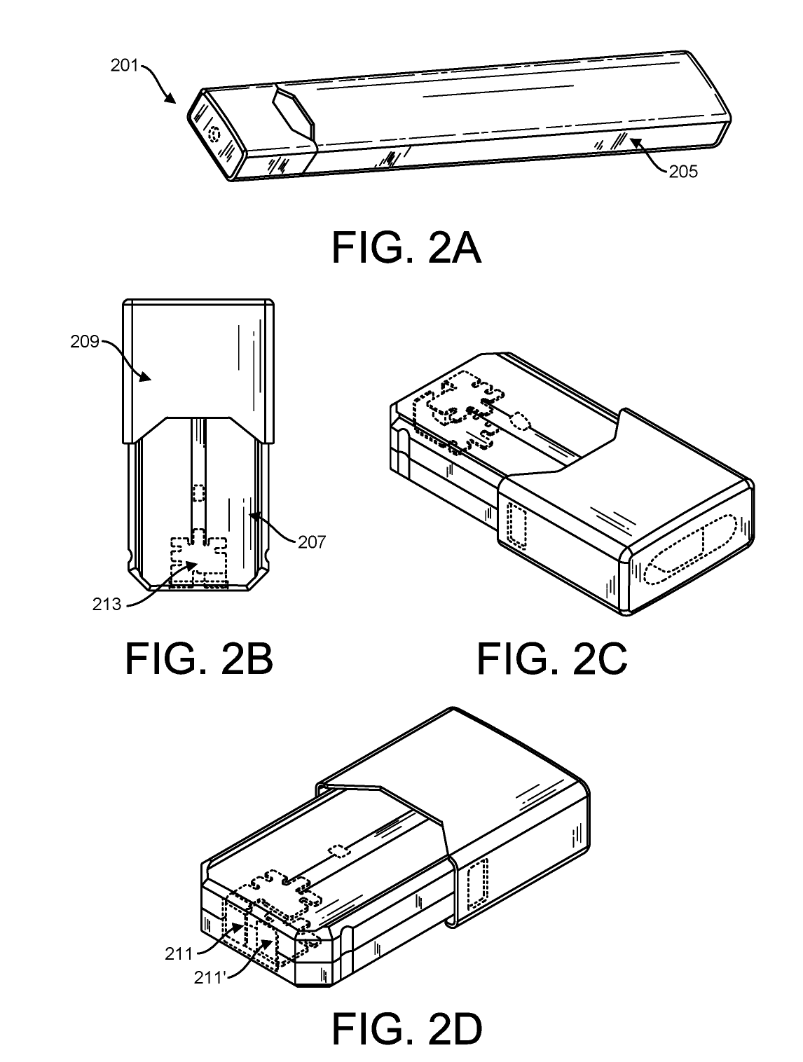

FIGS. 2A-2D illustrate another embodiment of the vaporizer cartridge 201 that can be stored in any of the storage containers described herein and can include any of the features described above with respect to the vaporizer cartridge 101 illustrated in FIGS. 1B-1D. For example, FIG. 2A shows the vaporizer cartridge 201 is coupled to another embodiment of a vaporizer device 205. As a further example, the vaporizer cartridge 201 can include a fluid reservoir that contains a vaporizable material 207, a mouthpiece 209 and a heater 213. The heater 213 can include a wick or wicking element, or it can be a wickless vaporizer. The heater 213 can include a pair of plates between which a resistive coil applies heat to some of the vaporizable material (e.g., thorough a wick) to form an inhalable vapor. One or more contacts 211, 211′ (e.g., plates or tabs) can be positioned along an outer surface of the vaporizer cartridge 201 or within an externally-accessible region, as shown in FIG. 2D, for connection with one or more connectors associated with the vaporizer device 205.

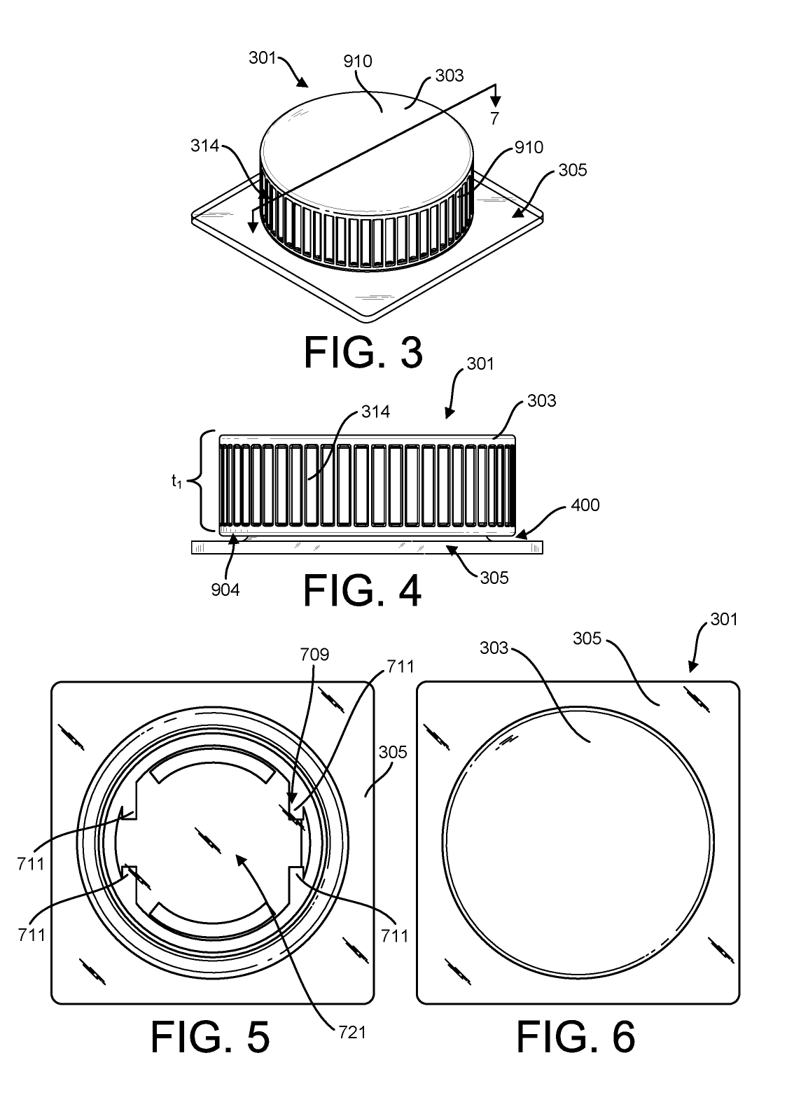

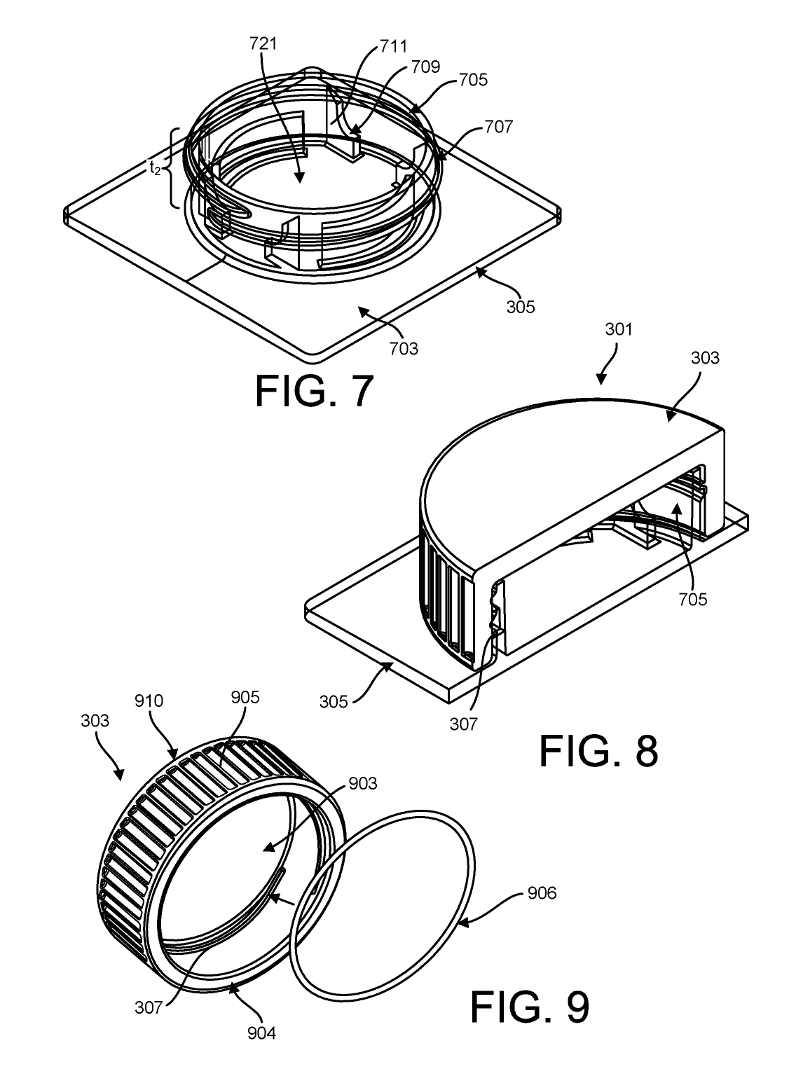

FIGS. 3-9 illustrate an embodiment of a storage container 301 including a container cap 303 and a container base 305. The container cap 303 can be releasably coupled to the container base 305 for securely storing a vaporizer cartridge (e.g., vaporizer cartridges 101, 201) therebetween. As shown in FIG. 7, the container base 305 can include a base plate 703 having a square or rectangular shape that extends along a plane. The base plate 703 can also include other shapes that are within the scope of this disclosure. The container base 305 can also include a base sidewall 705 that extends from the base plate 703 and defines a perimeter of a storage region 721. In some embodiments, the base sidewall 705 can define a circular perimeter, however, the base sidewall 705 can define any of a variety of shaped perimeters, such as square or rectangular.

As shown in FIG. 9, the container cap 303 can include an inner cap region 903 defined by a cap sidewall 905 extending from a cap top 910. The container cap 303 can be cylindrical and/or include a cylindrical inner cap region 903. However, the container cap 303, including the cap sidewall 905 and inner cap region 903 can have any of a variety of shapes and sizes. For example, the inner cap region 903 defined by the cylindrical cap sidewall 905 of the container cap 303 can be secured over the cylindrical base sidewall 705 of the container base 305 so that the vaporizer cartridge can be securely stored within the storage region 721. Furthermore, when the container base 305 is coupled to the container cap 303, one or more sections of the base plate 703 can extend outward from a perimeter of the container cap 303 by a distance, such as approximately 2 mm to approximately 15 mm. As another example, as shown in FIG. 4, when the container cap 303 is secured to the container base 305, a bottom surface 904 of the container cap 303 can be flush with the base plate 703 or a gap 400 can be formed therebetween. For example, the gap 400 can have a dimension of approximately zero mm to approximately 3 mm. Other dimensions and shapes of the container cap 303, container base 305, and gap 400 are within the scope of this disclosure. The base sidewall 705 can extend from the base plate 703 a height, t₂ (see FIG. 7), which can be the same as or less than the cap height, t₁ (see FIG. 4), so that the container cap can fit over the base sidewall 705.

As shown in FIG. 7, the base sidewall 705 can include a first coupling feature 707, such as threads and/or one or more interlocking features. For example, the first coupling feature 707 can be positioned along an outward-facing surface of the base sidewall 705 for engaging an inward facing surface of the cap sidewall 905, which can include a second coupling feature 307, such as threads and/or one or more interlocking features, as shown, for example, in FIGS. 8 and 9.

In some embodiments, an outer surface of the cap sidewall 905 can be textured, ribbed, or the like, such as to enhance a user's grip. For example, as shown in FIGS. 3 and 4, an outward facing surface of the cap sidewall 905 can include one or more vertically-oriented channels 314 that can assist with gripping the container cap 303. In use, for example, the container base 305 can be held in one hand while the container cap 303 is gripped by another hand. One or both hands can be used to apply one or more forces in one or more directions, such as either simultaneously or sequentially, to thereby uncouple the container cap 303 from the container base 305.

In some embodiments, the second coupling feature 307 of the container cap 303 can include a latch or other childproof locking mechanism that can engage the first coupling features 707 associated with the container base 305. For example, any number of a variety of childproof locking mechanisms can be included in the first or second coupling features 707, 307, such as any commercially available childproof locking mechanisms associated with containers (e.g., medicinal bottles, etc.), which can include any number and/or types of steps for locking and locking the childproof locking mechanisms (e.g., squeeze and twist, push and twist, etc.). For example, a user may need to apply a force perpendicular to the cap sidewall 905 (e.g., squeeze container cap 303) and either simultaneously or subsequently apply a force parallel to the cap sidewall 905 (e.g., rotate container cap 303) to unlock an engagement between the first and second coupling features 707 307 and uncouple the container cap 303 from the container base 305. As a further example, rotation of the container cap 303 relative to the container base 305 can require one or more of a variety of degrees of rotation of the container cap 303 relative to the container base 305, such as a 180 degrees or 90 degrees of rotation. In some embodiments, the container cap 303 can include an inner shell and a slip ring that can be manually engaged, e.g., by applying lateral force, to allow unscrewing of the cap. Any of the engagement mechanisms described herein between the container cap 303 and container base 305, such as the first and second coupling features 707, 307, can prevent children from accessing the vaporizer cartridges contained within the storage container, which can prevent injury and potentially harmful effects to children.

As shown in FIG. 7, the container base 305 can include a cradle 709 that is configured to maintain a position of the vaporizer cartridge within the storage container 301, such as within a particular orientation within the storage region 721. For example, the cradle 709 can include one or more opposing arms 711 that are shaped to conform to or mate against opposing sides of the vaporizer cartridge. As such, the cradle 709 can prevent movement at least in the direction of the opposing sides. In some embodiments one or more opposing arms 711 of the cradle can prevent movement of the engaged vaporizer cartridge in any direction, including once the container cap 303 has been coupled to the container base 305. This can prevent damage to the vaporizer cartridge and allow information associated with the vaporizer cartridge (e.g., printed, electronic, etc.) to be accessible and/or viewable, such as through a transparent part of the container base 305. As such, some embodiments of the cradle 709 can limit a position of the vaporizer cartridge for storage within the storage container to a single position that ensures such accessibility and/or viewing of information and/or contents (e.g., to determine whether the cartridge is full or empty) of the vaporizer cartridge. Furthermore, in some embodiments, the cradle 709 can be configured to couple to a vaporizer cartridge to thereby limit or prevent movement of the vaporizer cartridge in at least one direction. Additionally, the container cap 303 can further limit movement of the vaporizer cartridge coupled to the cradle 709 when the container cap 303 is secured to the container base 305. For example, an inner top surface of the container cap 303 can mate against a surface of the vaporizer cartridge thereby preventing movement of the vaporizer cartridge away from the cradle 709.

In some embodiments, the cradle 709 can include a plurality of ribs or struts that extend from the base plate 703 and/or base sidewall 705 and are configured to hold a vaporizer cartridge in a fixed orientation when the container cap is coupled to the container base. For example, the ribs or struts can be configured to prevent insertion of the cartridge orientations other than the fixed orientation. In some embodiments, the cradle 709 can be a molded feature that conforms loosely or tightly to at least part of an outline of the vaporizer cartridge to thereby hold the cartridge in at least one position.

FIG. 5 illustrates a bottom view of the storage container 301 showing the base plate 703 being made out of a transparent material thereby allowing viewing of at least the storage region 721. For example, all or part of the container base 305 can be transparent to allow viewing of the storage region 721 and the contents therein (e.g., vaporizer cartridge). In the example shown in FIG. 5, the storage region 721 does not include a vaporizer cartridge captured in the cradle 709. Alternatively or in addition to having transparent parts, the base plate 703 can include markings, e.g., printed, painted, screened or otherwise marked (including by a label that is adhesive applied, etc.), indicating contents and/or marketing. By having at least a part of the base plate 703 transparent, a user can easily see when a vaporizer cartridge is present within the storage container 301, as well as determine a color, fullness, and/or other characteristics of the vaporizer cartridge.

In some embodiments, all or a part of the storage container 301 can be made out of a transparent material or an opaque material. Furthermore, any appropriate material may be used to form the container base 305 and/or container cap 303, including acrylics (e.g., polymethlamethacrylate), butyrates (e.g., cellulose acetate butyrate), polycarbonate (e.g., Lexan), PETG (e.g., glycol modified polyethylene terphthalate), etc. Alternatively or in addition, various other materials can be used, any of which can include different optical properties (e.g., transparencies). For example, the base plate 703 can be transparent while the base sidewalls 705 and/or cradle 709 can be formed of a material that is different from the base plate 703 material.

FIG. 8 illustrates a cross-section view of the storage container 301 in which the cap 303 is fully engaged with the base 305. As shown the inner cap region 903 can fit entirely over the cylindrical sidewall 705 of the container base 305 so that a vaporizer cartridge positioned in the cradle 709 can be enclosed within both the storage region 721 and the inner cap region 903 when the container cap 303 is coupled to the container base 305. As shown in FIG. 9, a seal (e.g., gasket, o-ring, etc.) can be associated with either the container cap 303 or container base 305, such has for positioning between the container cap 303 and container base 305 to thereby provide additional sealing therebetween. For example, such additional sealing can prevent air from entering the storage container and oxidizing the vaporizable material, thus prolonging shelf-life and freshness of the vaporizable material, as well as prolonging the effectiveness of the active ingredient. The additional sealing can also prevent odors from escaping the storage container, as well as prevent any fluid leaks that may occur from the vaporizer cartridge to escape the storage container. For example, FIG. 9 shows the container cap 303 and an embodiment of a gasket or seal 906 that can be positioned adjacent a bottom surface 904 or cap sidewall 905 of the container cap 303. In some embodiments, the gasket or seal 906 may be a conical silicone gasket, shown or any other appropriate (particularly rubber or rubbery) material may be used. In some variations the seal 906 can be placed over the cylindrical sidewall and/or in the inner cap region. Furthermore, one or more seals 906 may be included in the storage container 301.

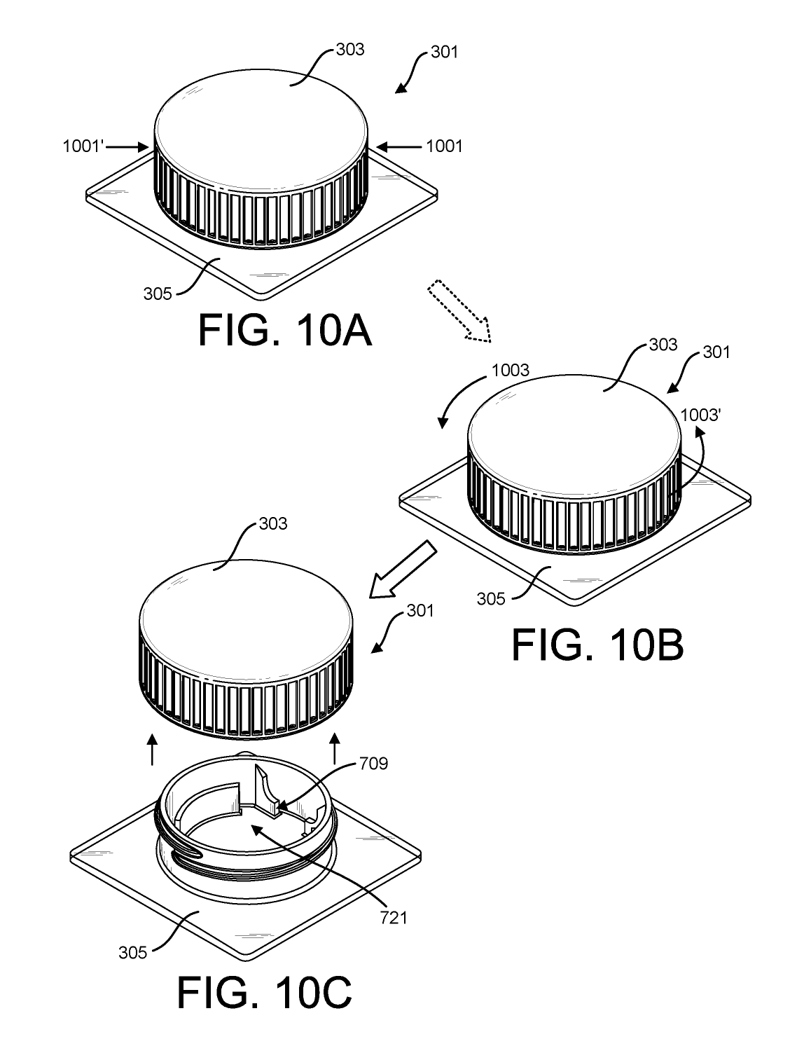

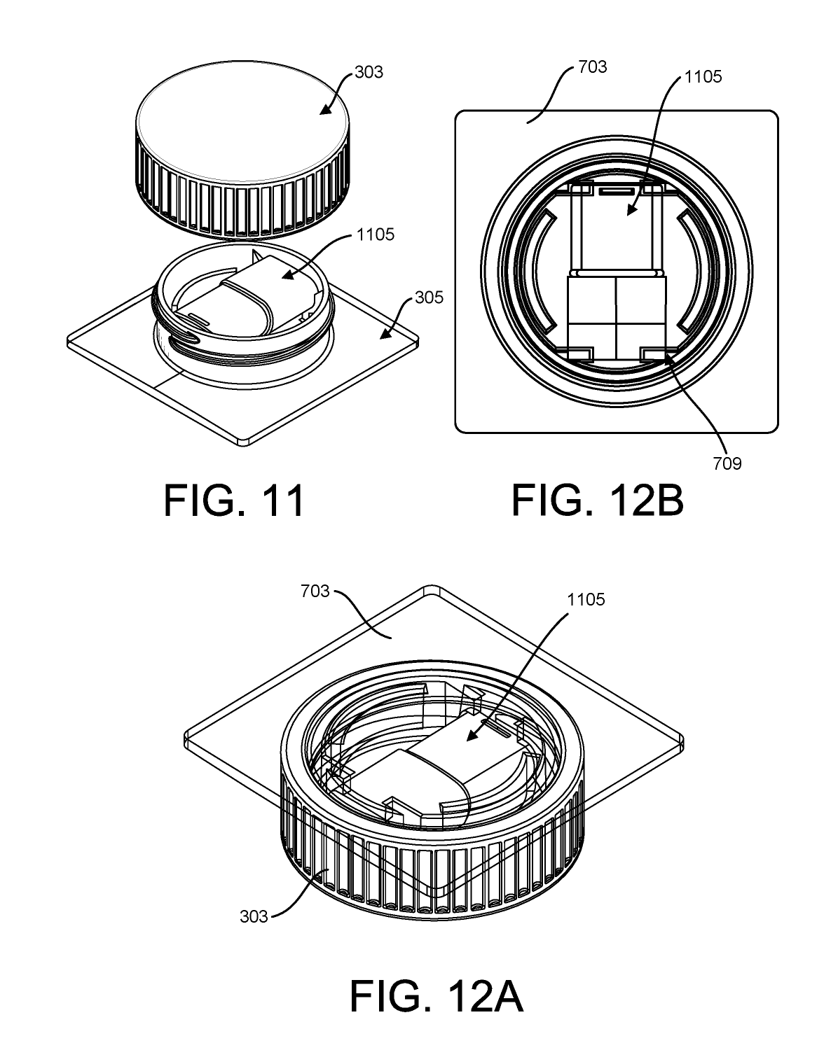

FIGS. 10A-10C illustrate one example of a method of operating an embodiment of a storage container, such as the storage container 301 described above. In some embodiments in which the storage container 301 includes a child safety feature such as a child-proof or child-resistant locking mechanism, the storage container 301 can be opened by generally applying two or more different motions and/or forces to remove the cap from the base, including as discussed above. For example, any one of a pushing on a top surface of the container cap 303, a twisting of the container cap, and/or a squeezing of the container cap 303 can assist with allowing the container cap to be uncoupled from the container base 305. For example, as shown in FIG. 10A, a user may first apply a squeezing force (e.g., as shown by force arrows 1001, 1001′ directed at opposite sides of the container cap 303), which can engage the first and second coupling features 707, 307 (e.g., threads, latches, and/or childproof features). Such engaging of the first and second coupling features 707, 307 can subsequently allow application of a twisting force (e.g., as shown by force arrows 1003, 1003′ directed along the side of the container cap 303, as shown in FIG. 10B). The squeezing and twisting forces can be applied simultaneously or sequentially. As shown in FIG. 10C, once uncoupled, the container cap 303 can be moved away from the container base 305 thereby allowing access to the storage region 721, such as for loading or unloading a vaporizer cartridge, as shown in FIG. 11.

As mentioned above, when a vaporizer cartridge is contained within a storage container, it can be viewed through a transparent part of the base plate 703, as shown in FIG. 12A. In this example, a vaporizer cartridge 1105 can be seen through the transparent base plate 703 when the container cap 303 is coupled to the container base 305. FIG. 12B shows a bottom view of the storage container with the cartridge 1105 positioned within the cradle 709, which can also be visible through the base plate 703.

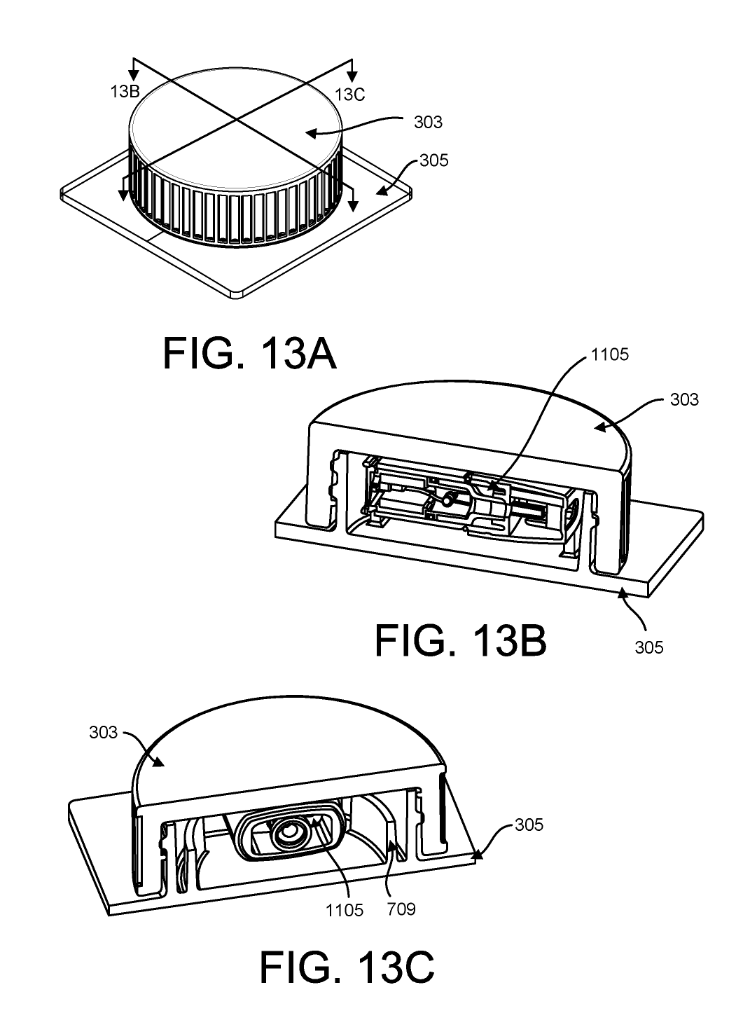

FIGS. 13B and 13C illustrate sectional views of FIG. 13A showing an example of the container cap 303 fully engaged with the container base 305 and the vaporizer cartridge 1105 being contained within both the inner cap region 903 of the container cap 303 and the storage region 721 of the container base 703. As shown, minimal excess volume is included in the storage container with the vaporizer cartridge contained therein. This allows the storage container to have a compact configuration. For example, the top of the inner cap region 903 can either contact or be slightly separated from the cartridge (e.g., by less than approximately 1 mm to approximately 4 mm.).

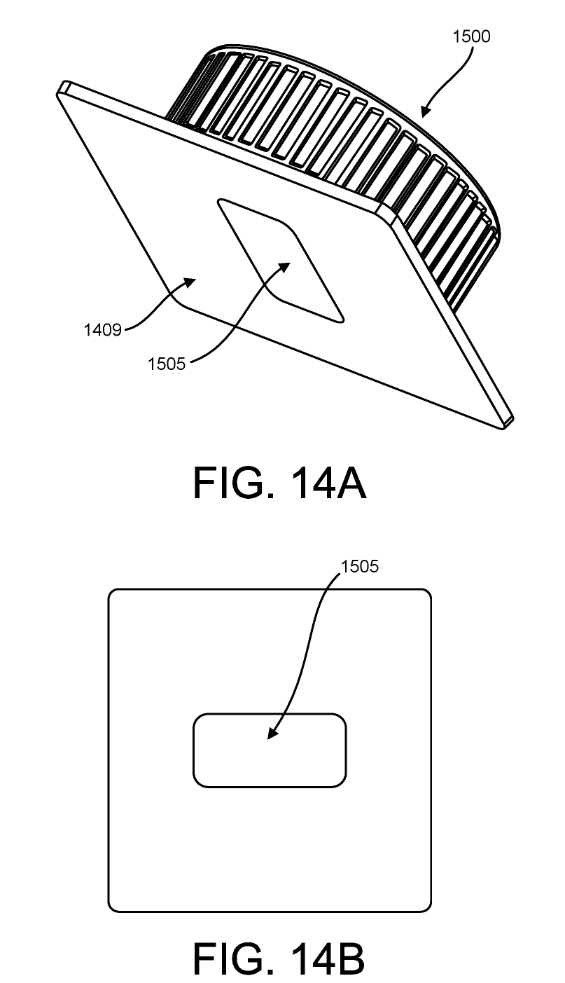

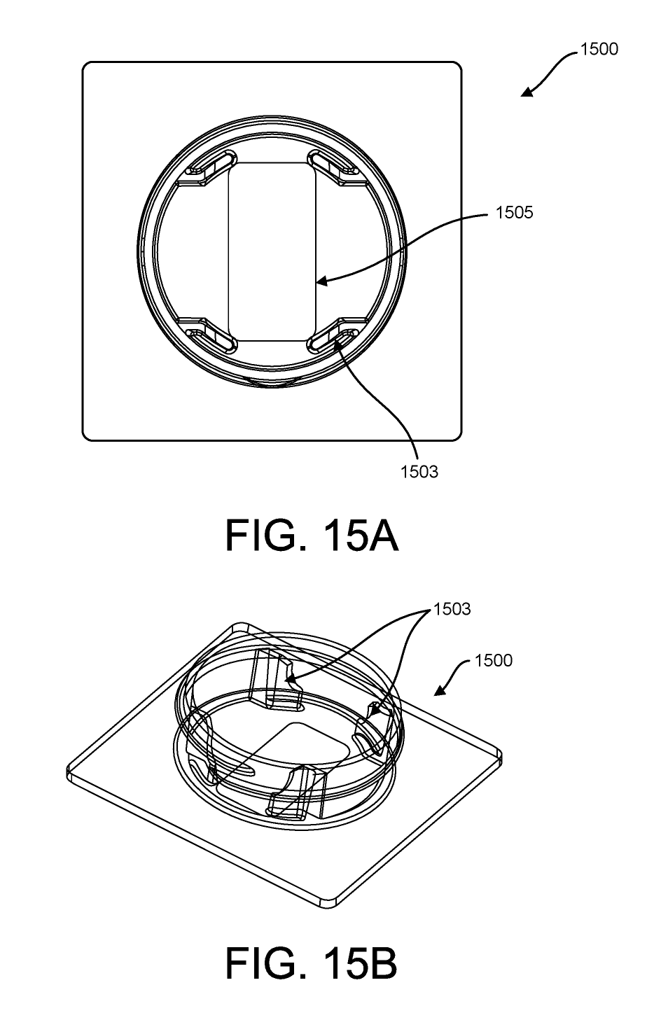

FIGS. 14A and 14B illustrate another example of a storage container 1500 that can include any of the features discussed above, such as with respect to storage container 301, and can further include a transparent window region 1505 that can allow for viewing of contents (e.g., vaporizer cartridge) contained in the storage container, as discussed above. The storage container, in FIGS. 15A and 15B, can include another embodiment of a cradle 1503 that includes two pair of ribs that can engage opposite ends of a vaporizer cartridge to position the vaporizer cartridge over the transparent window region 1505 thereby ensuring the contents and any indications associated with the vaporizer cartridge can be viewed through the window region 1505.

Some embodiments of the storage containers can be covered or coated (e.g., printed, painted, screened, etc.) with a non-transparent (e.g., solid, opaque, translucent, etc.) material along all or a portion of its surface. A window 1505 may be left uncovered so that the cartridge may be viewed within the apparatus through the window.

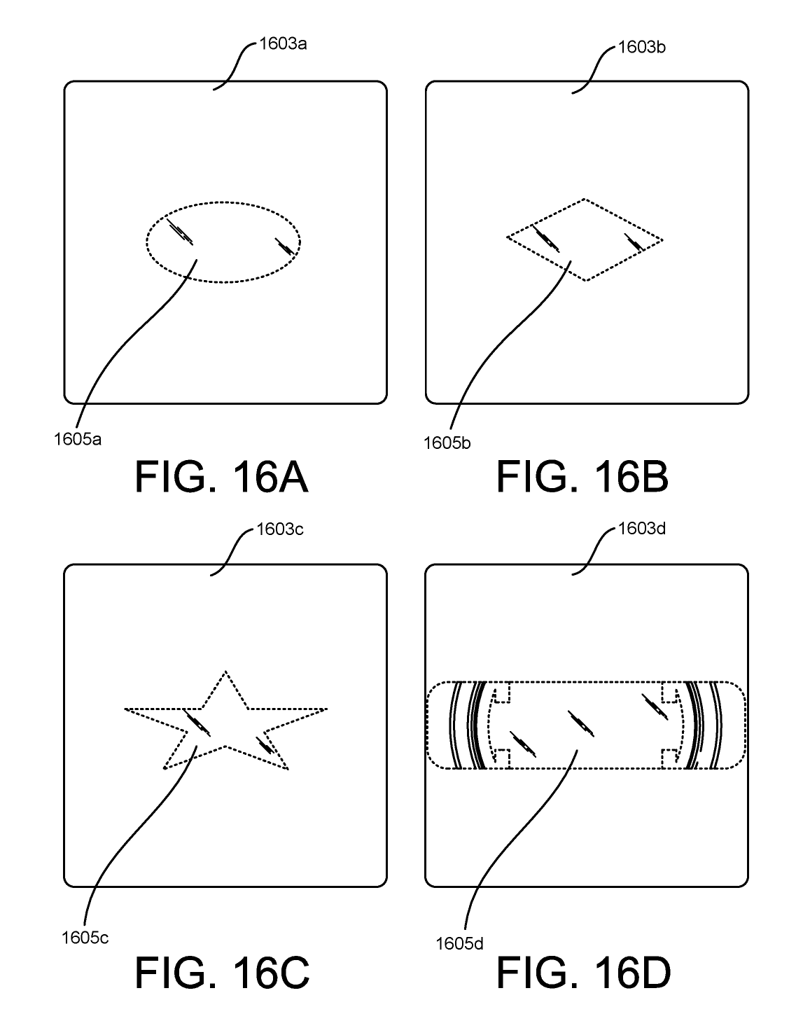

For example, FIGS. 14A and 14B illustrate a storage container in which the bottom flat surface (flat base plate) is covered/printed with an opaque material 1409 such as a paint or ink, while a window 1505 is left unpainted to allow visualization of the cartridge through the base plate. This window may be any appropriate shape and size. FIGS. 16A-16D illustrate example of windows having different shapes and sizes. These transparent windows may be aligned with the cradle so that the cartridge, when held in the cartridge so that it can be snugly fitted into the apparatus, is aligned with the window. For example, FIG. 16A shows an embodiment of a base plate 1603a including an oval-shaped transparent window 1605a, FIG. 16B shows an embodiment of a base plate 1603b including a diamond-shaped transparent window 1605b, FIG. 16C shows an embodiment of a base plate 1603c including a star-shaped transparent window 1605c, and FIG. 16D shows an embodiment of a base plate 1603d including a rectangular-shaped transparent window 1605d.

A method associated with the storage container can include coupling a vaporizer cartridge to a cradle positioned within a storage region of a storage container. The storage container can include a container base including the storage region defined by a base sidewall extending from a base plate. The method can further include securing a container cap of the storage container to the container base to thereby contain the vaporizer cartridge in the storage container. In some embodiments, the method can further include positioning the vaporizer cartridge relative to a transparent window along the base plate to thereby allow viewing of at least one side of the vaporizer cartridge when the vaporizer cartridge is contained within the storage container. In some embodiments, the method can further include locking a first coupling feature along the base sidewall to a second coupling feature along the cap sidewall to thereby restrict uncoupling of the container cap from the container base. In some embodiments, the method can further include applying a first force against at least one of the cap sidewall and the base sidewall. The first force can be directed perpendicular to the at least one of the cap sidewall and the base sidewall. Additionally, the method can further include applying a second force against the at least one of the cap sidewall and the base sidewall, the second force being directed parallel to the at least one of the cap sidewall and the base sidewall. Furthermore, at least one of the applying the first force and the applying the second force can unlock the first coupling feature from the second coupling feature thereby allowing uncoupling of the container cap from the container base. The cradle can include a pair of opposing coupling arms that are configured to releasably secure opposing sides of the vaporizer cartridge, and the vaporizer cartridge can include a reservoir for storing a vaporizable material and an interface for coupling to a vaporizer device. In addition, the method can further include depositing a vaporizable material in the reservoir of the vaporizer cartridge.

In any of the embodiments described herein, the inner region of the storage container can include an absorbent material (e.g., for absorbing fluid that leaks from the cartridge). For example, the inner region may include a sponge material or a fibrous material. Alternatively or additionally, in some variations the inner region can include a desiccant.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A storage container, comprising:
a container base including a storage region defined by a base sidewall extending from a base plate, the base sidewall including a first coupling feature;
a cradle positioned within the storage region for releasably securing an item within the storage region; and
a container cap including an inner cap region defined by a cap sidewall extending from a cap top, the cap sidewall including a second coupling feature that releasably couples to the first coupling feature to thereby releasably couple the container cap to the container base.

2. A storage container as in claim 1, wherein the item is a vaporizer cartridge having a reservoir for storing a vaporizable material and an interface for coupling to a vaporizer device.

3. A storage container as in claim 1, wherein the first coupling feature includes a first cap interlock that engages a first base interlock of the second coupling feature when the container cap is secured to the container base, the first cap interlock being prevented from disengaging the first base interlock before a first force is applied to the storage container.

4. A storage container as in claim 3, wherein the first coupling feature includes a second cap interlock that releasably engages a second base interlock of the second coupling feature when the container cap is secured to the container base, the second cap interlock being prevented from disengaging the second base interlock before a second force is applied to the storage container.

5. A storage container as in claim 4, wherein uncoupling of the container cap to the container base is prevented before the first and second force is applied to the storage container.

6. A storage container as in claim 4, wherein uncoupling of the container cap to the container base is prevented before the first and second force is applied simultaneously to the storage container.

7. A storage container as in claim 3, wherein the first force is directed perpendicular to the cap sidewall.

8. A storage container as in claim 4, wherein the second force is directed parallel to the cap sidewall.

9. A storage container as in claim 1, wherein the base sidewall forms a first circular perimeter having a first diameter and the cap sidewall forms a second circular perimeter having a second diameter, wherein the second diameter is greater than the first diameter for allowing the cap sidewall to be positioned adjacent and outside of the base sidewall when the container cap is coupled to the container base.

10. A storage container as in claim 1, wherein the cradle includes a pair of opposing coupling arms that are configured to releasably secure opposing sides of the item.

11. A storage container as in claim 1, wherein the cradle limits a positioning of the item substantially to a single secured position within the storage region.

12. A storage container as in claim 1, wherein at least a part of the base is made out of a translucent material thereby allowing viewing of contents within the storage region when the container cap is coupled to the container base.

13. A storage container as in claim 1, wherein when the container cap is coupled to the container base the cap sidewall extends over an outward-facing side of the base sidewall and a bottom surface of the container cap is positioned adjacent an upper surface of the base plate.

14. A method, comprising:
coupling a vaporizer cartridge to a cradle positioned within a storage region of a storage container, the storage container comprising a container base including the storage region defined by a base sidewall extending from a base plate; and
securing a container cap of the storage container to the container base to thereby contain the vaporizer cartridge in the storage container.

15. A method as in claim 14, further comprising:
positioning the vaporizer cartridge relative to a transparent window along the base plate to thereby allow viewing of at least one side of the vaporizer cartridge when the vaporizer cartridge is contained within the storage container.

16. A method as in claim 14, further comprising:
locking a first coupling feature along the base sidewall to a second coupling feature along the cap sidewall to thereby restrict uncoupling of the container cap from the container base.

17. A method as in claim 16, further comprising:
applying a first force against at least one of the cap sidewall and the base sidewall, the first force being directed perpendicular to the at least one of the cap sidewall and the base sidewall; and
applying a second force against the at least one of the cap sidewall and the base sidewall, the second force being directed parallel to the at least one of the cap sidewall and the base sidewall;
wherein at least one of the applying the first force and the applying the second force unlocks the first coupling feature from the second coupling feature thereby allowing uncoupling of the container cap from the container base.

18. A method as in claim 14, wherein the cradle includes a pair of opposing coupling arms that are configured to releasably secure opposing sides of the vaporizer cartridge.

19. A method as in claim 14, wherein the vaporizer cartridge comprises a reservoir for storing a vaporizable material and an interface for coupling to a vaporizer device.

20. A method as in claim 19, further comprising:
depositing a vaporizable material in the reservoir of the vaporizer cartridge.
